(19) United States
(12) Patent Application Publication
(10) Pub. No.: US 2008/0040142 A1
(43) Pub. Date: Feb. 14, 2008

(54) METHOD AND SYSTEM FOR A USER INTERFACE FOR A LIVE SPEED DATING SESSION OVER A WORLD WIDE NETWORK OF COMPUTERS

(75) Inventor: STANLEY LIU, South Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Atomic Bullfrog LLC, Pasadena, CA (US)

(21) Appl. No.: 11/782,599

(22) Filed: Jul. 24, 2007

Related U.S. Application Data
(60) Provisional application No. 60/833,446, filed on Jul. 25, 2006.

(51) Int. Cl. G06Q 99/00

(52) U.S. Cl. 705/1

(57) ABSTRACT

A method for live speed dating through a world wide network of computers, e.g., Internet. The method includes inputting one or more parameters through a client device to a server device from a first human user. In a preferred embodiment, the one or more parameters includes a sexual preference (e.g., male, female) and an age range. In a specific embodiment, the client device is coupled to the server device through a computer network coupled to a world wide network of computers. In a specific embodiment, the method includes processing the one or more parameters of the first human user. The method includes maintaining a pool of more than two other human users to be matched with the first human user. In a specific embodiment, the pool of other human users includes at least four or more, but can be others. In a specific embodiment, the method includes outputting at least a second visual image of one of the other human users to be matched with the one or more parameters of the first human user within a first predetermined amount of time to the first human user on the client device. The method includes communicating from the first human user to at least one of the other human users for a second predetermined amount of time through the network of computers. In a preferred embodiment, the network of computers is configured for communicating in substantially real time between the first human user and the other human user. The method includes determining if the one human user during the second predetermined amount of time is an accept or a reject.

### CROSS-REFERENCES TO RELATED APPLICATIONS

The present application claims priority to U.S. Application Ser. No. 60/833,446 filed Jul. 25, 2006, commonly assigned, and hereby incorporated by reference herein.

### COPYRIGHT NOTICE

Certain portions of the present patent specification, including the user interfaces, have been specifically reserved and protected under U.S. copyright laws. Copyright©2006 Atomic Bullfrog LLC. All rights have been reserved.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to communicating through a world wide network of computers. More particularly, the present method and system includes a way of communicating between a first and second human user using a live speed dating technique. Merely by way of example, the invention has been applied using a one wide network of computers, such as the Internet. But it would be recognized that the invention has a much broader range of application.

In the early days of America, a large population of immigrants was often required to meet increasing demands of labor so courtship evolved to meet the needs of immigrants. Many times, single men were encouraged to marry at a young age. Courtship, or more commonly now dating, became a necessity for a future husband to support a wife and family to support the ever increasing needs of America. Often times, parents focused on the practical family to help support the ever increasing workload of the America in its early days. That is, parents encouraged their children to marry and have grandchildren to support the demanding workload placed on the early America settlers.

Often times, people seeking mates could often find them in social activities such as church and other settings. Parents typically assisted in the match making between unwed men and women. Alternatively, aunts, uncles, and other family members and even friends helped with the match making between men and women. Rabbi Yaacov Deyo of Aish HaTorah has been credited for bringing together large numbers of Jewish singles to help meet and marry them in what we call as “speed dating.” Although someone effective, match making was often difficult and lead to unhappy marriages and the like. Additionally, the unwed men and women often had a limited number of potential dates using the limited network of family and friends.

Most recently in the past decades, dating has become a process of eliminating people that were not worthy of becoming a marriage partner or friend. That is, dating often begins at a young age, where numerous unworthy people are eliminated through the process. In today's computer age, Internet dating services have emerged. One of the first online dating services was created in the mid-1990's and is known as “match.com,” which is at www.match.com

Much of the services were initially simple and compared or matched couples based upon their likes and dislikes. That is, complex user profiles were created that lead to a long drawn out process of finding the “right” mate. Other online dating services include Friendster, Inc. of San Francisco, Calif. Examples of Friendster's technology has been described in U.S. Pat. No. 7,117,254, entitled “Method for Inducing Content Uploads in a Social Network,” and U.S. Pat. No. 7,069,308, entitled “System, Method and Apparatus for Connecting Users in an Online Computer System Based on Their Relationships within Social Networks.” Although somewhat effective, online dating services still have many limitations and may not bring together the perfect couples.

From the above, it is seen that techniques for improved dating services is highly desired.

### BRIEF SUMMARY OF THE INVENTION

According to the present invention, techniques related to communicating through a world wide network of computers are provided. More particularly, the present method and system includes a way of communicating between a first and second human user using a live speed dating technique. Merely by way of example, the invention has been applied using a one wide network of computers, such as the Internet. But it would be recognized that the invention has a much broader range of application.

In a specific embodiment, the present invention provides a method for live speed dating through a world wide network of computers, e.g., Internet. The method includes inputting one or more parameters through a client device to a server device from a first human user. In a preferred embodiment, the one or more parameters includes a sexual preference (e.g., male, female) and an age range. In a specific embodiment, the client device is coupled to the server device through a computer network coupled to a world wide network of computers. In a specific embodiment, the method includes processing the one or more parameters of the first human user. The method includes maintaining a pool of more than two other human users to be matched with the first human user. In a specific embodiment, the pool of other human users includes at least four or more, but can be others. In a specific embodiment, the method includes outputting at least a second visual image of one of the other human users to be matched with the one or more parameters of the first human user within a first predetermined amount of time to the first human user on the client device. The method includes communicating from the first human user to at least one of the other human users for a second predetermined amount of time through the network of computers. In a preferred embodiment, the network of computers is configured for communicating in substantially real time between the first human user and the other human user. The method includes determining if the one human user during the second predetermined amount of time is an accept or a reject.

In an alternative specific embodiment, the present invention provides a method for live speed dating through a world wide network of computers, e.g., Internet. The method includes inputting one or more parameters through a client device to a server device from a first human user. In a specific embodiment, the one or more parameters includes a sexual preference and an age range. The client device is coupled to the server device through a computer network coupled to a world wide network of computers. The method includes processing the one or more parameters of the first human user. In a specific embodiment, the method includes deriving a pool of more than two other human users to be matched with the first human user from the one or more parameters from the first human user. The method includes initiating a dating session between the first human user and one of the other human users. The method includes outputting at least a second visual image of the one other human user for a first predetermined amount of time to the first human user on the client device. The method includes communicating in substantially real time between the first human user to the one of the other human users for a second predetermined amount of time through the network of computers. The method includes selecting an appearance rating from 1 through N, where N is the integer greater than 1, for appearance of the one of the other human users by the first human user. The method includes selecting a personality rating from 1 through M, where M is an integer greater than 1, for personality of the one of the other human users by the first human user. The method includes selecting an intelligence rating from 1 through O, where O is an integer greater than 1, for intelligence of the one of the other human users by the first human user. The method includes selecting a sexiness rating from 1 through P, where P is an integer greater than 1, for sexiness of the one of the other human users by the first human user. In a specific embodiment, the method determines if the one human user during the second predetermined amount of time is an accept or a reject by the first human user.

In yet an alternative specific embodiment, the present invention provides a method for live speed dating through a world wide network of computers. The method includes initiating a speed dating session from a client device between a first user and a plurality of second users by referencing a time from a timer. The method includes outputting a first visual representation of the first user to one of the second users at a second client device. In a specific embodiment, the method includes outputting a second visual representation of the second user to the first user at the first client device. The method communicates in substantially real time between the first user and the second user through the network of computers. In a specific embodiment, the method includes determining if the one human user during a predetermined amount of time is an accept or a reject by the first human user.

Still further, the present invention provides a system for live speed dating through a world wide network of computers. In a preferred embodiment, the system comprising one or more tangible computer readable medium. One or more codes is configured to initiate a speed dating session from a client device between a first user and a plurality of second users by referencing a time from a timer. One or more codes is configured to output a first visual representation of the first user to one of the second users at a second client device. One or more codes configured to output a second visual representation of the second user to the first user at the first client device. One or more codes is configured to allow communication in a substantially real time between the first user and the second user through the network of computers. One or more codes is configured to accept an indication to determine if the one human user during a predetermined amount of time is an accept or a reject by the first human user. Depending upon the embodiment, there can be other codes to carry out the functionality described herein.

Many benefits are achieved by ways of present invention. For example, the present invention provides a method and system that can be implemented using conventional computer based technology. Additionally, the present invention can include a method and system for providing one or more of the following benefits.

1. Fastest and safest way to meet and find a match between people on-line;

2. Caters to casual and serious dating clients;

3. Intuitive and automated interfaces that is easy to use;

4. Fun, addictive, and viral marketing; and

5. Platform for large, interactive, and social networking

Depending on the embodiment, One or more of the benefits can be achieved. These and other benefits will be described in more detailed throughout the present specification and particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified flow diagram of a speed dating method according to an embodiment of the present invention.

FIG. 2 is a simplified flow diagram of a speed dating method according to an alternative embodiment of the present invention.

FIG. 3 is a simplified diagram of a computer network system according to an embodiment of the present invention.

FIG. 4 is a simplified diagram of a client device according to an embodiment of the present invention.

FIG. 5 is a simplified block diagram of the client device of FIG. 4 according to an embodiment of the present invention.

FIGS. 6-20 are graphical user interfaces according to embodiments of the present invention.

FIG. 21 is a simplified flow diagram of a speed dating sign up process according to an embodiment of the present invention.

FIG. 22 is a simplified flow diagram of a speed dating component work flow according to an embodiment of the present invention.

FIG. 23 is a simplified flow diagram of an on-demand speed data according to an embodiment of the present invention.

FIG. 24 is a simplified flow diagram of a live request speed date according to an embodiment of the present invention.

### DESCRIPTION OF THE INVENTION

According to the present invention, techniques related to communicating through a world wide network of computers are provided. More particularly, the present method and system includes a way of communicating between a first and second human user using a live speed dating technique. Merely by way of example, the invention has been applied using a one wide network of computers, such as the Internet. But it would be recognized that the invention has a much broader range of application.

A method for entering personal information for live speed dating, according to a specific embodiment, is briefly outlined below.

1. Sign up for an account from a client device on a server device;

2. Enter speed dating website on the server device from the client device;

3. Input one or more parameters (e.g., sexual preference, age range) through the client device to the server device from a first human user;

4. Process the one or more parameters of the first human user to determine a pool of more than two other human user to be matched or not matched with the first human user;

5. Maintain the pool of more than two other human users to be matched or unmatched with the first human user; and

6. Perform other steps as desired.

The above sequence of steps provides a method according to an embodiment of the present invention. In a specific embodiment, the present invention provides a method for creating a pool of potential candidates for a live speed dating session. Merely by way of example, the pool of users has been created using a sexual preference and age range preference according to a specific embodiment. Other alternatives can also be provided where steps are added, one or more steps are removed, or one or more steps are provided in a different sequence without departing from the scope of the claims herein. Details of the present method and structure can be found throughout the present specification and more particularly below.

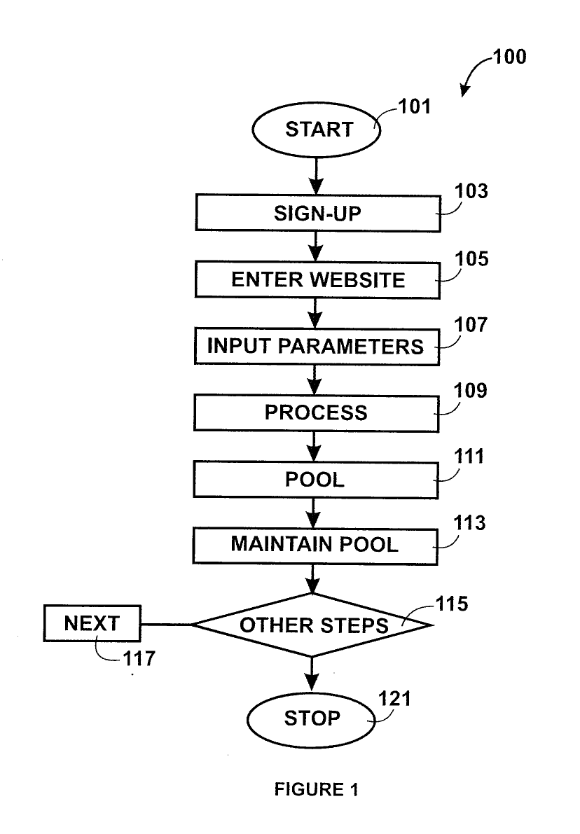

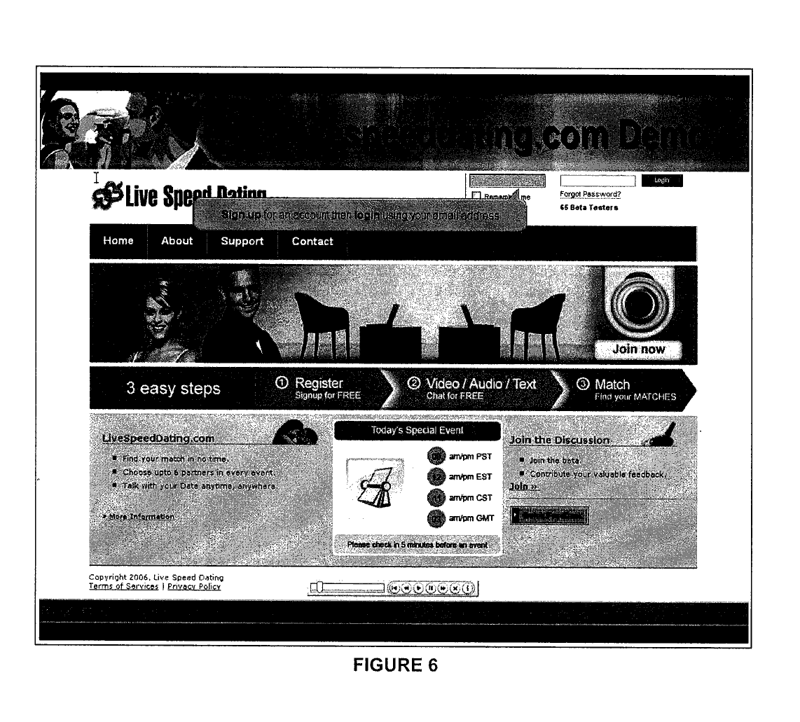

FIG. 1 is a simplified flow diagram 100 of a speed dating method according to an embodiment of the present invention. This diagram is merely an example, which should not unduly limit the scope of the claims herein. One of ordinary skill in the art would recognize other variations, modifications, and alternatives. As shown, the present method begins with start, step 101. In a specific embodiment, the method includes signing up (step 103) for an account from a client device on a server device. In a specific embodiment, the account includes a user name, password, and other parameters. In a preferred embodiment, the user account is an electronic mail address and related password, but can be other information. In a specific embodiment, the account can be entered via web page in FIG. 6, as an example. Of course, there can be other variations, modifications, and alternatives.

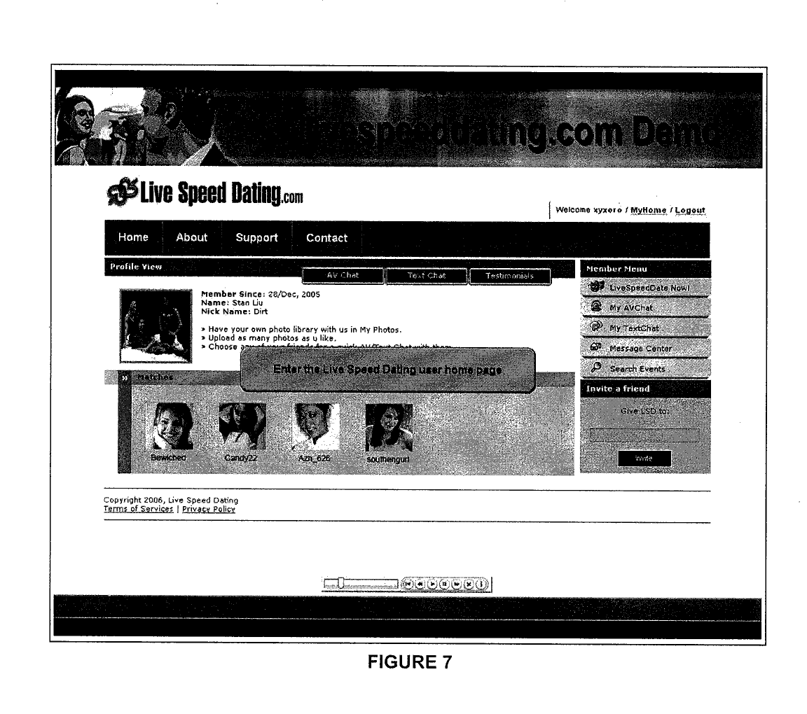

In a specific embodiment, the present method includes entering (step 105) a speed dating website on the server device from the client device. Again the web set can direct at least three steps, such as registering, video/audio/text communication, and match process. In a specific embodiment, the present user inputs one or more parameters (e.g., sexual preference, age range) (step 107) through the client device to the server device. In a specific embodiment, the present method processes (step 109) the one or more parameters of the user to determine a pool (step 111) of more than two other human user to be matched or not matched with the first human user. As merely an example, FIG. 7 outputs a plurality of human users such as user names including Bewiched, Candy22, Azn_{—}626, and southengurl, but can be others. As shown, each of the plurality of human users includes respective photograph or visual representation. Of course, there can be other variations, modifications, and alternatives.

Referring back to FIG. 1, the present method maintains (step 113) the pool of more than two other human users to be matched or unmatched with the first human user. In a specific embodiment, the method performs other steps (step 115) as desired. If other steps are desired, the present method processes block 117. Alternatively, the present method ends at stop, step 121. Depending upon the embodiment, the present method can include other processes such as those explained in more detail throughout the present specification and more particularly below. Of course, there can be other variations, modifications, and alternatives.

As shown, the present invention provides a method for creating a pool of potential candidates for a live speed dating session. Merely by way of example, the pool of users has been created using a sexual preference and age range preference according to a specific embodiment. Other alternatives can also be provided where steps are added, one or more steps are removed, or one or more steps are provided in a different sequence without departing from the scope of the claims herein.

In a specific embodiment, the present invention provides a method for a live speed dating session, which may be outlined briefly below.

1. Sign up for an account from a client device on a server device;

2. Enter speed dating website on the server device from the client device;

3. Select speed dating process;

4. Check into a live event;

5. Enter audio video check pre launched area;

6. Enter live speed dating session;

7. Perform live one on one chat between a first human user and one of a plurality of second human users;

8. Monitor time period associate with the one on one chat to be maintained within a predetermined time period;

9. Select a rating for appearance for the second human user from the client device;

10. Select a rating for personality for the second human user from the client device;

11. Select a rating for intelligence from the second human user from the client device;

12. Select a rating for sexiness from the second human user from the client device;

14. Select a match or reject the match for the second user from the client device.

15. Enter text message as a testimonial from the first user to the second human user;

16. Submit the match;

17. Generate a report associated with the second user from the plurality of second users;

18. Select a report to be purchased from the plurality of second users;

19. Purchase the report associated with the selected second user; and

20. Perform other steps, as desired.

The above sequence of steps provides a method according to an embodiment of the present invention. In a specific embodiment, the present invention provides a method for performing a live speed date session between a first users and a plurality of second users. Merely by way of example, the pool of users has been created using a sexual preference and age range preference according to a specific embodiment. Other alternatives can also be provided where steps are added, one or more steps are removed, or one or more steps are provided in a different sequence without departing from the scope of the claims herein. Details of the present method and structure can be found throughout the present specification and more particularly below.

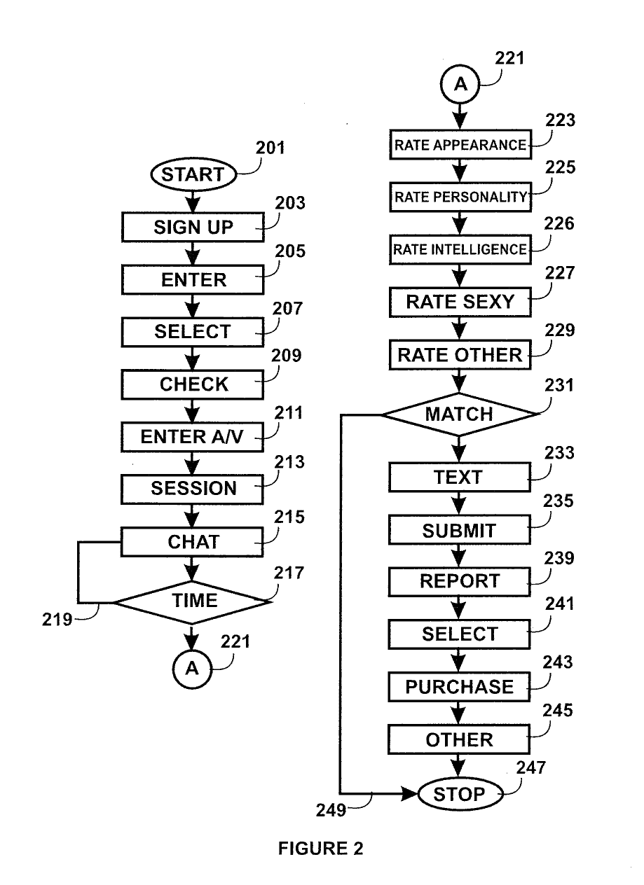

FIG. 2 is a simplified flow diagram 200 of a speed dating method according to an alternative embodiment of the present invention. This diagram is merely an example, which should not unduly limit the scope of the claims herein. One of ordinary skill in the art would recognize other variations, modifications, and alternatives. As shown, the present method begins with start, step 201. In a specific embodiment, the method includes signing up (step 203) for an account from a client device on a server device. In a specific embodiment, the account includes a user name, password, and other parameters. In a preferred embodiment, the user account is an electronic mail address and related password, but can be other information. In a specific embodiment, the account can be entered via web page in FIG. 6, as an example. Of course, there can be other variations, modifications, and alternatives.

In a specific embodiment, the present method includes entering (step 205) a speed dating website on the server device from the client device. Again the web set can direct at least three steps, such as registering, video/audio/text communication, and match process. In a specific embodiment, the present user inputs one or more parameters (e.g., sexual preference, age range) through the client device to the server device. In a specific embodiment, the present method processes the one or more parameters of the user to determine a pool of more than two other human user to be matched or not matched with the first human user. As merely an example, FIG. 7 outputs a plurality of human users such as user names including Bewiched, Candy22, Azn_{—}626, and southengurl, but can be others. As shown, each of the plurality of human users includes respective photograph or visual representation. Of course, there can be other variations, modifications, and alternatives.

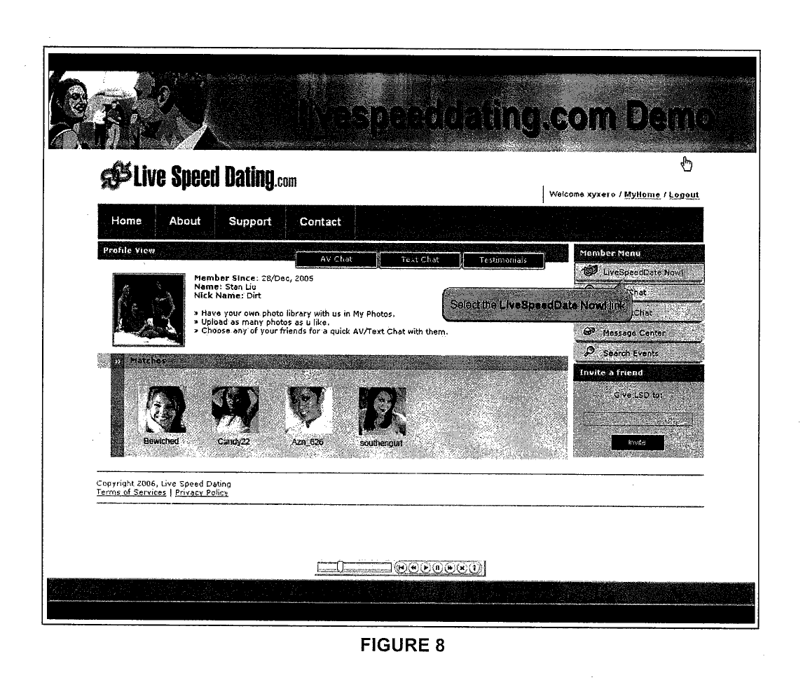

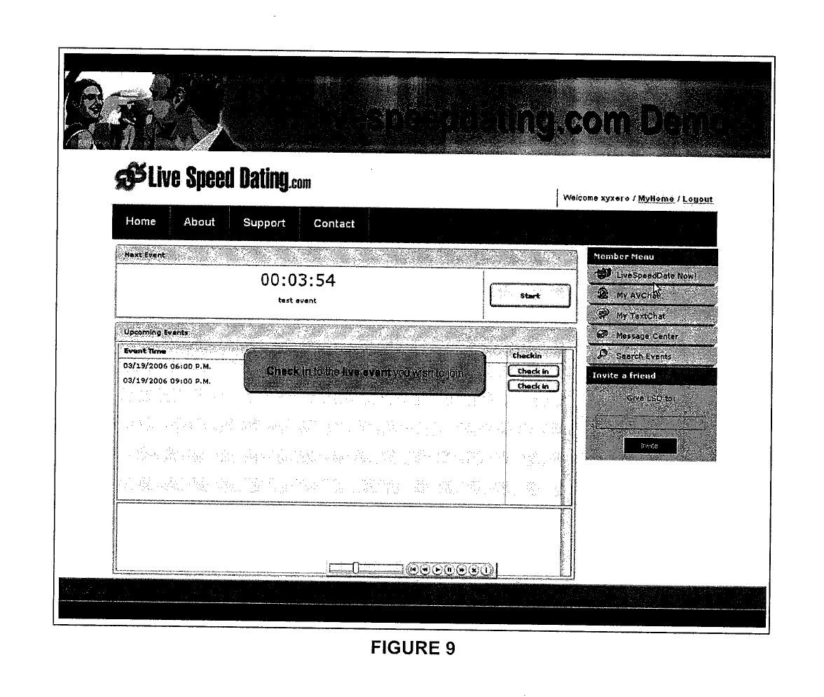

Referring back to FIG. 1, the present method selects (step 207) speed dating process. As shown in FIG. 8, the user selects a LiveSpeedDate now! icon, which begins the process. Referring now to FIG. 9, the method outputs a time (e.g., 3:54) for a next event according to a specific embodiment. As merely an example, the present method and user can check into (step 209) a live event, which has been indicated as Mar. 19, 2006 at 06:00 P.M. or alternatively Mar. 19, 2006 at 09:00 P.M. Of course, there can be other variations, modifications, and alternatives. In the present method, the user selects a Check In icon corresponding to one of the sessions according to a specific embodiment.

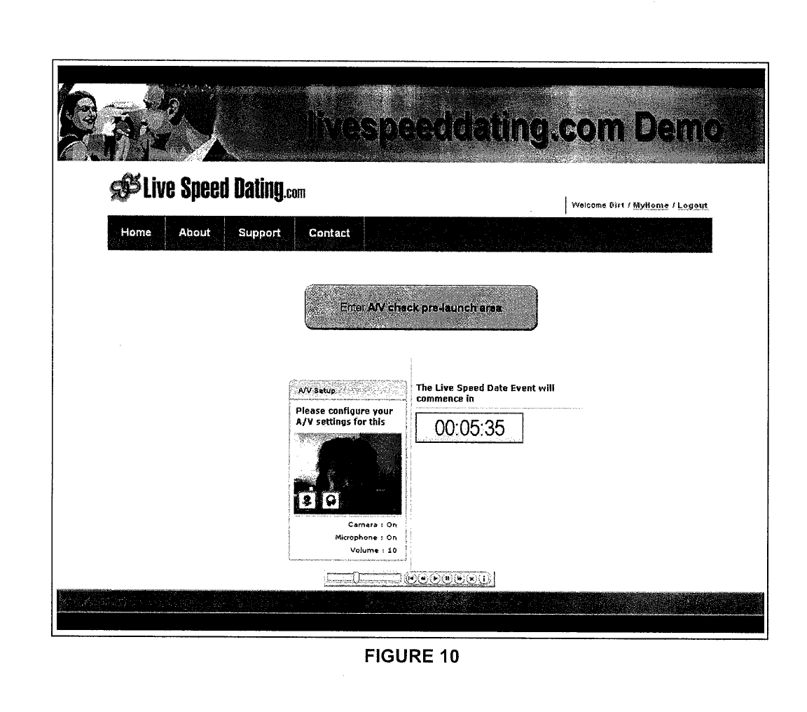

Referring back to FIG. 1 again, the method includes entering (step 211) audio video check pre launched area. Referring to FIG. 10, the present method outputs a audio/video output, which is a moving image of a first user, according to a specific embodiment. In a specific embodiment, the method configures audio/video settings for a camera, microphone, and associated volume. As also shown, an associated time illustrates when the speed dating session begins. Additionally, the method outputs a tool bar, which shows icons for adjusting volume, brightness, and other graphical and/or audio features. Of course, there can be other variations, modifications, and alternatives.

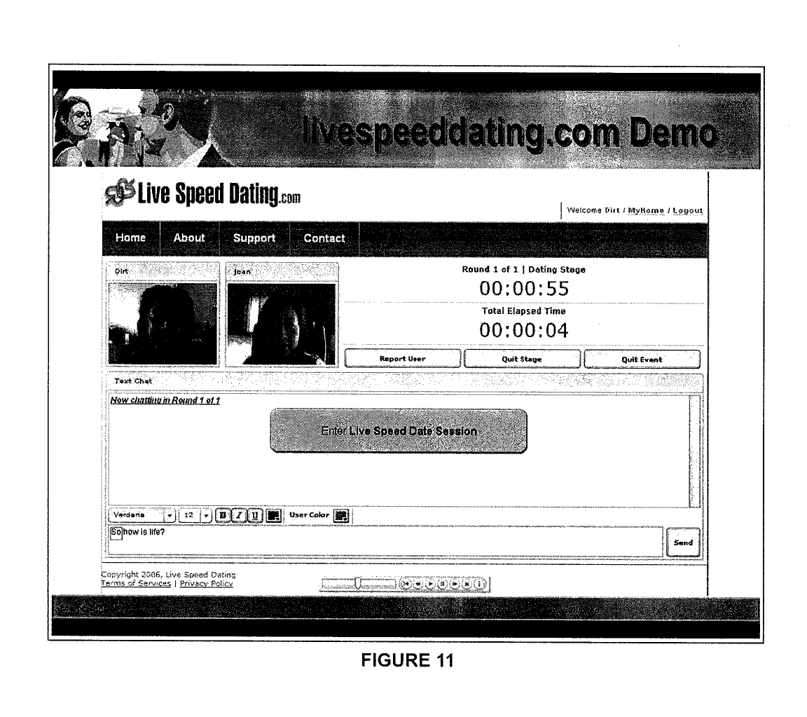

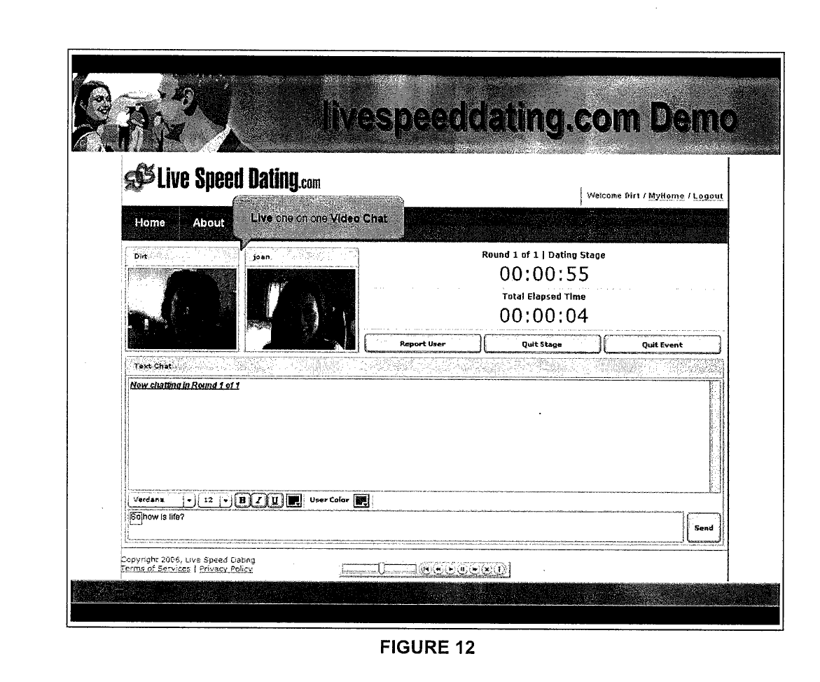

In a specific embodiment, the present method initiates a speed dating session, step 213 in FIG. 2. As merely an example, the present method outputs a video of a first user named Dirt and a video of a second user named joan, as illustrated by FIG. 11. In a specific embodiment, each of the videos is shown side by side, but can be in other configurations. In a specific embodiment, the method outputs a total time available (e.g., 55 seconds) and an elapsed time, e.g., 4 seconds. In a specific embodiment, one of the users can input text such as “So how is life?” as shown. In a preferred embodiment, the present method performs a live one or one chat between the two users, including the first user and the second user, as illustrated by FIG. 12.

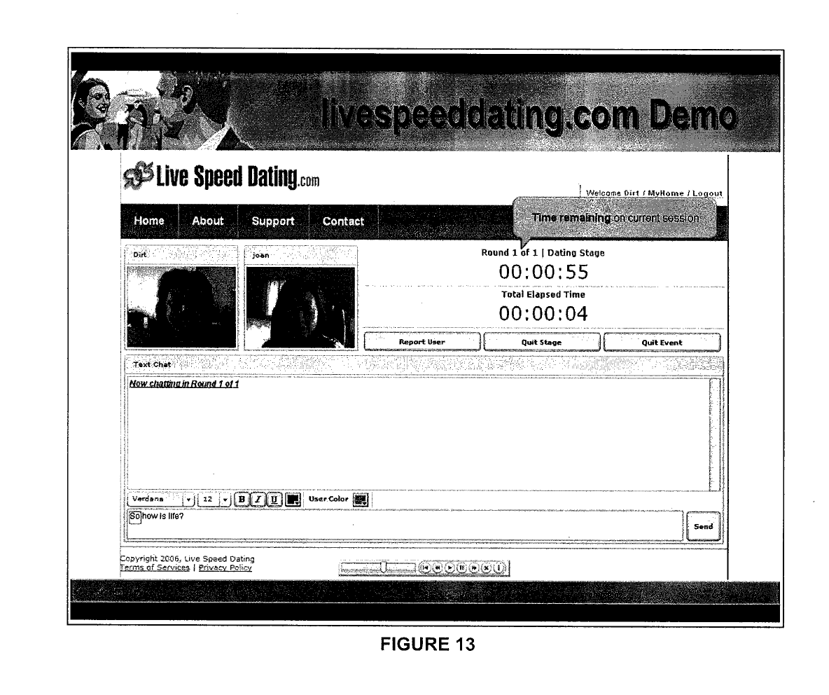

Referring back to FIG. 2, the method monitors (step 217) a time period associate with the one on one chat to be maintained within a predetermined time period, step 219. In a specific embodiment, the present method can monitor a time period associated with the one or one chat or any combination of the steps recited herein as well as others. See also FIG. 13. In a specific embodiment, the predetermined time period often ranges from about 1 minute or so, but can be slightly more or slightly less. Of course, there can be other variations, modifications, and alternatives. In FIG. 2, connector A 221 connects the two flows, which have been illustrated.

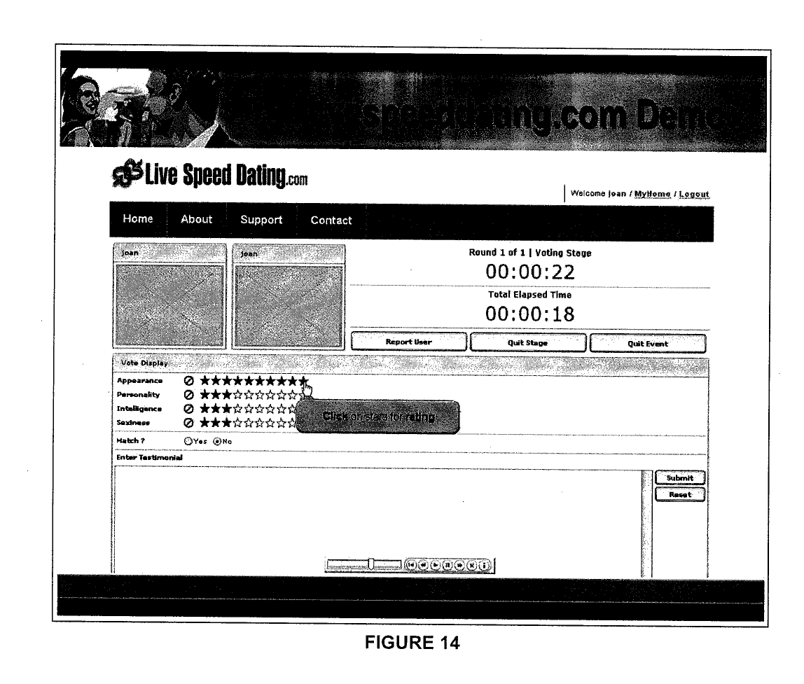

In a specific embodiment, the present method selects one or more ratings for the second user by the first user, and the other way around (step 229) according to a specific embodiment. In a specific embodiment, the present method selects (step 223) a rating for appearance for the second human user from the client device. In a specific embodiment, the present method selects a rating (step 225) for personality for the second human user from the client device. In a specific embodiment, the present method selects (step 226) a rating for intelligence from the second human user from the client device. In a specific embodiment, the present method selects (step 227) a rating for sexiness from the second human user from the client device. Referring to FIG. 14, the present method illustrates high rating for appearance (numbered from 1 through N), but lower ratings on personality, intelligence, and sexiness. Overall, the method provides a “No” for the match, see also branch 249, which leads to stop, step 247. Accordingly, the present method selects a match or reject the match for the second user from the client device.

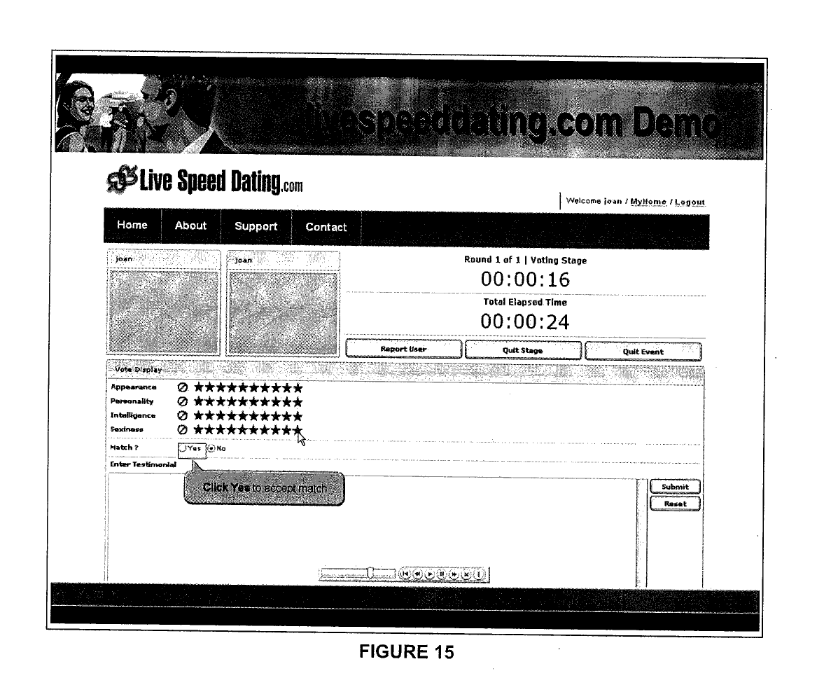

Alternatively, the present method selects one or more ratings for the second user by the first user, and the other way around (step 229) according to a specific embodiment. More particularly, the present method selects a match icon, which has been illustrated by FIG. 15. In a specific embodiment, the present method selects (step 223) a rating for appearance for the second human user from the client device. In a specific embodiment, the present method selects a rating (step 225) for personality for the second human user from the client device. In a specific embodiment, the present method selects (step 226) a rating for intelligence from the second human user from the client device. In a specific embodiment, the present method selects (step 227) a rating for sexiness from the second human user from the client device. Referring again to FIG. 15, the present method illustrates high ratings for appearance, personality, intelligence, and sexiness (numbered from 1 through N, where N is 10 stars). Overall, the method provides a “Yes” for the match, which leads to step 233, which will be described in more detail below.

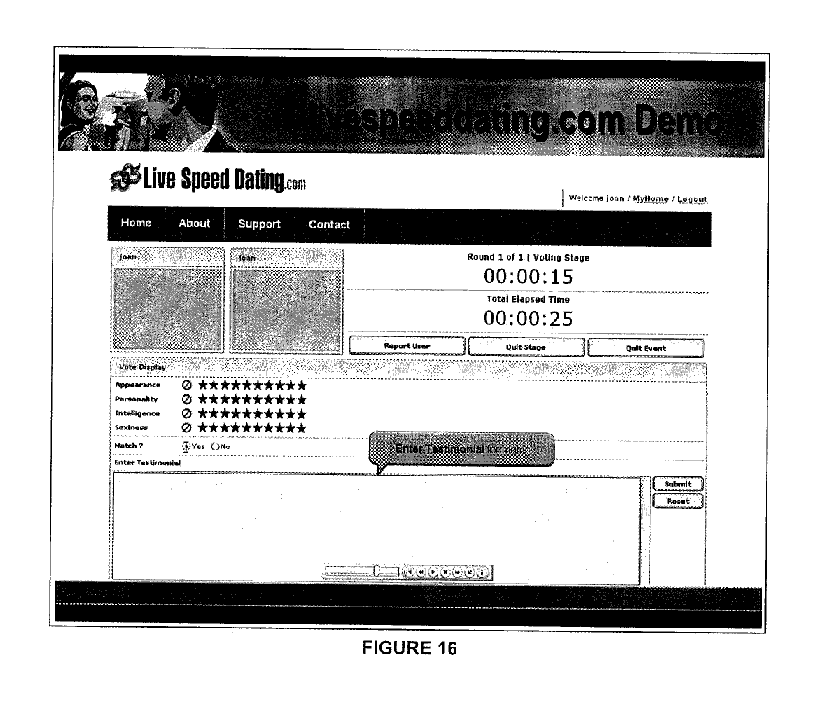

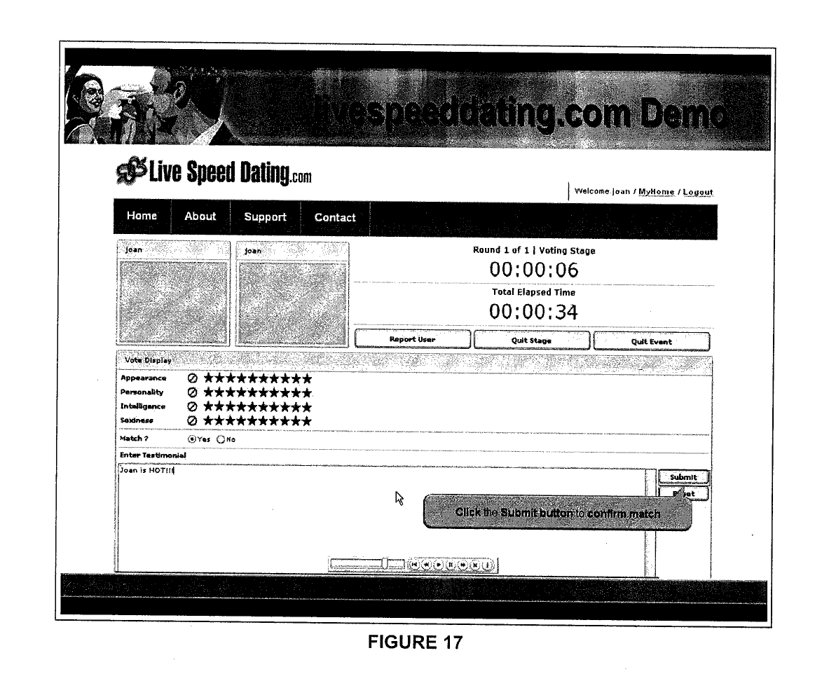

In a specific embodiment, the present method enter text message (step 233) or text as a testimonial from the first user to the second human user. In a specific embodiment, the text is entered in a field, which is below the display region for the vote and match, as illustrated by FIG. 16. See also FIG. 17, “Joan is HOT!!!.” Of course, there can be other variations, modifications, and alternatives. In a specific embodiment, the method submit (step 235) the match via an icon in another region of the user interface. Again, there can be other variations, modifications, and alternatives.

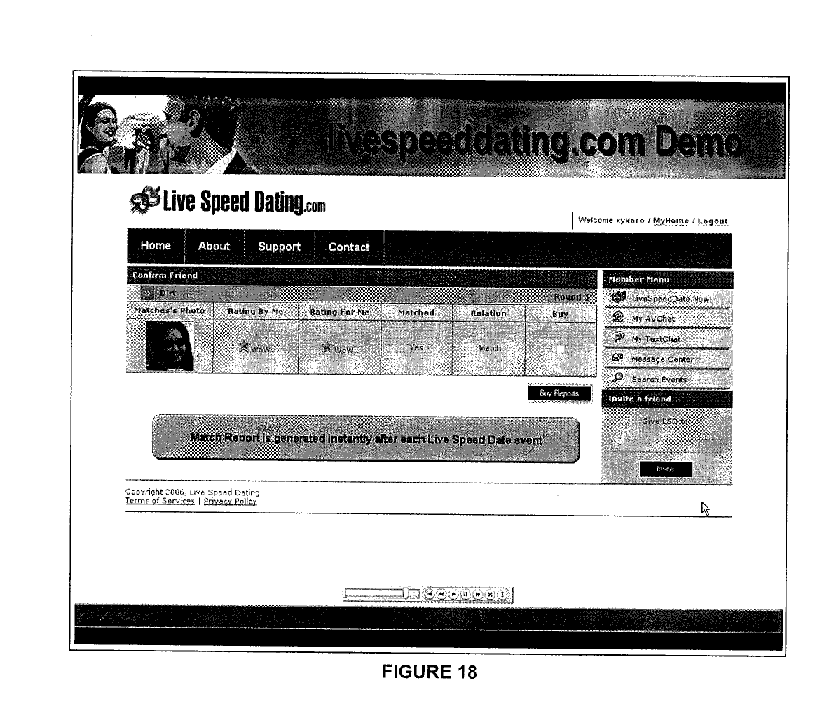

Once the user submits the match, the present method generates a report, step 239), which occurs in real time. In a specific embodiment, the report is generated within about ten seconds or less and even within seconds or less. As merely an example as illustrated by FIG. 18, the method generates the report associated with the second user from the plurality of second users. As shown, the report outputs a visual image (e.g., photograph) of the second user, rating (e.g., Wow) for the second user by the first user, rating (e.g., Wow) by the second user for the first user, “Yes” for matched, and matched relationship. In a specific embodiment, the method also illustrates a selection to select or not select a repot associated with the second user.

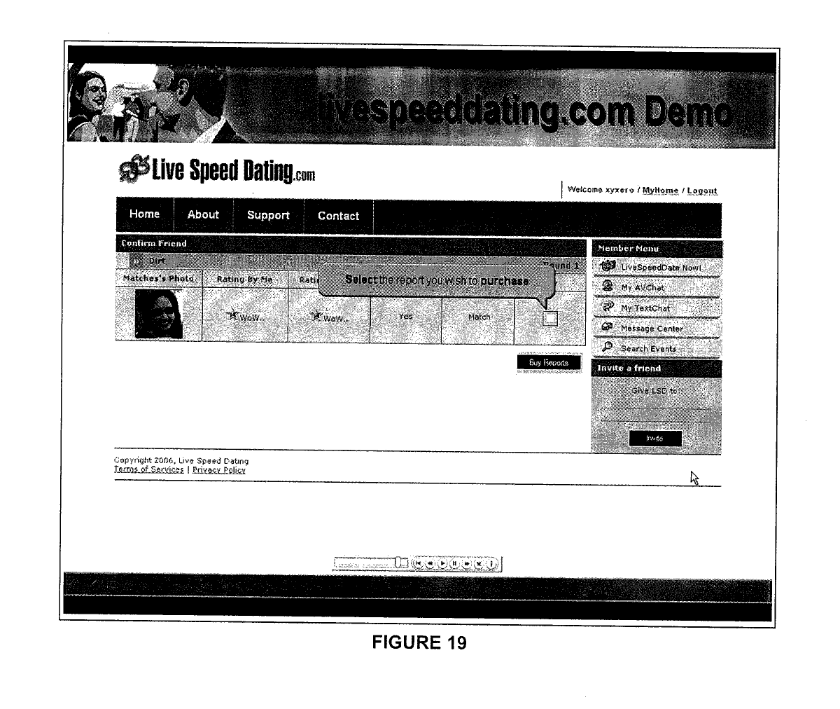

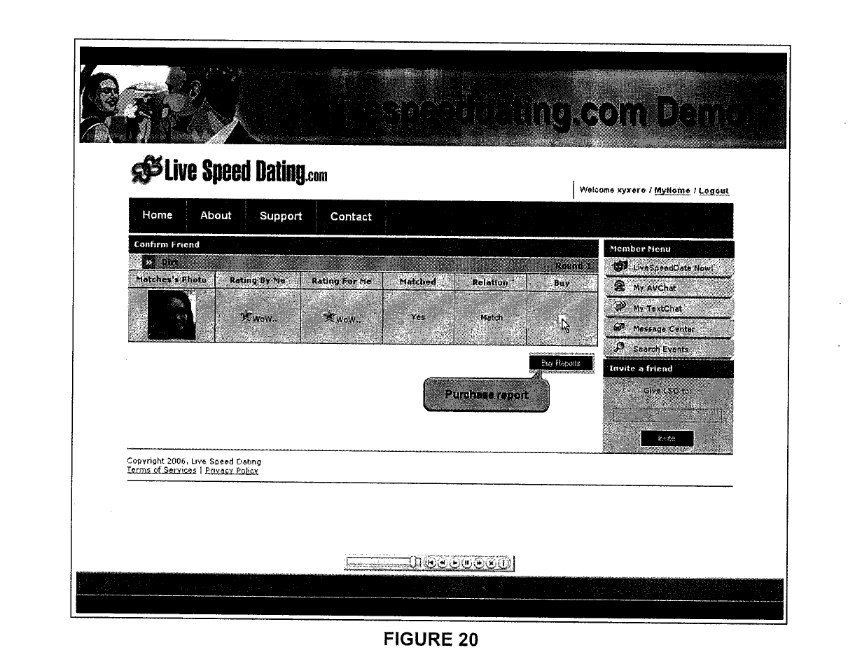

Referring to FIG. 18, the user selects (step 241) the “Buy” indication to purchase (step 243) the report associated with the selected second user. See also FIGS. 19 and 20. In a specific embodiment, the method can use an on-line payment method such as PayPal or credit card to pay for the report. In a preferred embodiment, the user pays for the report but does not pay for any of the processes associated with the other steps. Accordingly, it is fairly easy for the user to use the present method without any costs, unless a match has been made between the user and another user. In a specific embodiment, the method performs other steps, step 245. Depending upon the embodiment, the method ends at stop, step 247. Of course, there can be other variations, modifications, and alternatives. Depending upon the embodiment, the present method can include other processes such as those explained in more detail throughout the present specification and more particularly below. Of course, there can be other variations, modifications, and alternatives.

As shown, the present invention provides a method for creating a pool of potential candidates for a live speed dating session. Merely by way of example, the pool of users has been created using a sexual preference and age range preference according to a specific embodiment. Other alternatives can also be provided where steps are added, one or more steps are removed, or one or more steps are provided in a different sequence without departing from the scope of the claims herein.

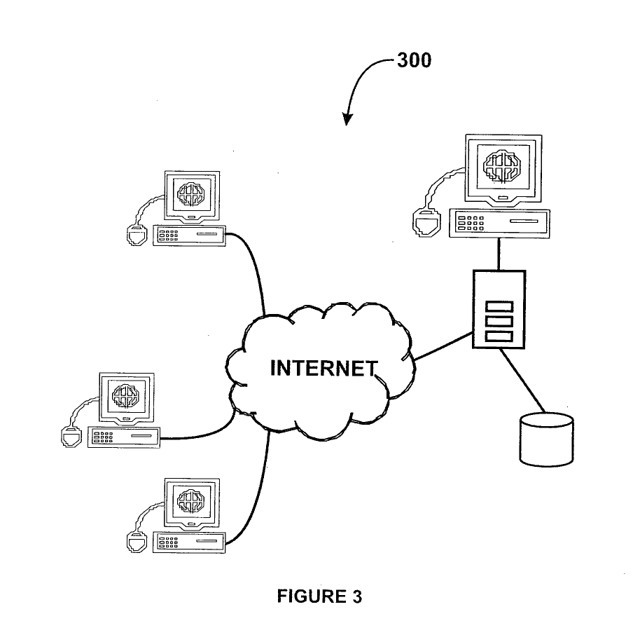

FIG. 3 is a simplified diagram 300 illustrating a computer network system for speed dating according to an embodiment of the present invention. This diagram is merely an example, which should not unduly limit the scope of the claims herein. One of ordinary skill in the art would recognize other variations, modifications, and alternatives. Of course, there can be other variations, modifications, and alternatives.

Depending upon the specific embodiment, the system is overseen and controlled by one or more computer systems, including a microprocessor and/controllers. In a preferred embodiment, the computer system or systems include a common bus, oversees and performs operation and processing of information. The system also has a display, which can be a computer display, coupled to the control system 400, which will be described in more detail below. Of course, there can be other modifications, alternatives, and variations. Further details of the present system are provided throughout the specification and more particularly below.

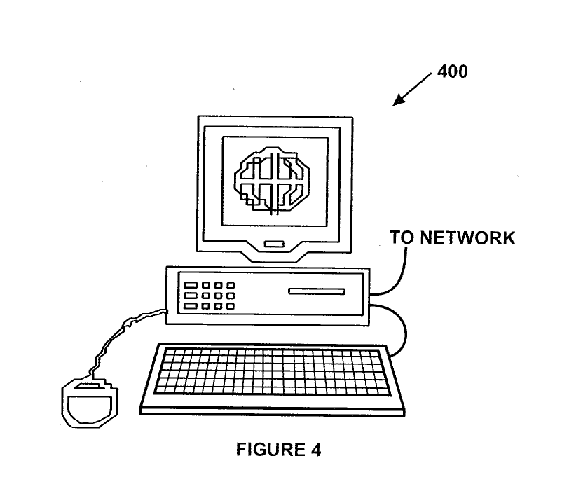

FIG. 4 is a detailed diagram of a computing system 400 according to an embodiment of the present invention. This diagram is merely an example, which should not unduly limit the scope of the claims herein. One of ordinary skill in the art would recognize other variations, modifications, and alternatives. As shown, the computer system includes display device, display screen, cabinet, keyboard, scanner and mouse. Mouse and keyboard are representative “user input devices.” Mouse includes buttons for selection of buttons on a graphical user interface device. Other examples of user input devices are a touch screen, light pen, track ball, data glove, microphone, and so forth.

The system is merely representative of but one type of system for embodying the present invention. It will be readily apparent to one of ordinary skill in the art that many system types and configurations are suitable for use in conjunction with the present invention. In a preferred embodiment, computer system 400 includes a Pentium™ class based computer, running Windows™ NT operating system by Microsoft Corporation or Linux based systems from a variety of sources. However, the system is easily adapted to other operating systems and architectures by those of ordinary skill in the art without departing from the scope of the present invention. As noted, mouse can have one or more buttons such as buttons. Cabinet houses familiar computer components such as disk drives, a processor, storage device, etc. Storage devices include, but are not limited to, disk drives, magnetic tape, solid-state memory, flash memory, bubble memory, etc. Cabinet can include additional hardware such as input/output (I/O) interface cards for connecting computer system to external devices external storage, other computers or additional peripherals, which are further described below.

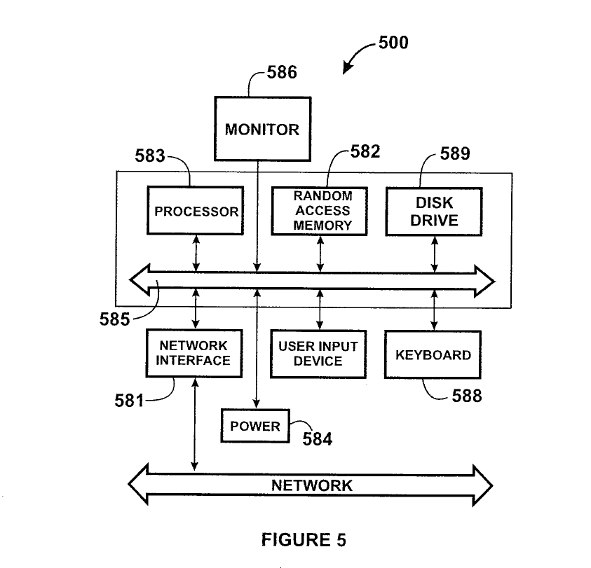

FIG. 5 is a block diagram 500 of the computing system of FIG. 4 according to an embodiment of the present invention. This diagram is merely an example, which should not unduly limit the scope of the claims herein. One of ordinary skill in the art would recognize other variations, modifications, and alternatives. As shown, basic subsystems are included in computer system 400. In specific embodiments, the subsystems are interconnected via a system bus 585. Additional subsystems such as a printer 584, keyboard 588, fixed disk 589, monitor 586, which is coupled to display adapter, and others are shown. Peripherals and input/output (I/O) devices 581, which couple to I/O controller, can be connected to the computer system by any number of means known in the art, such as serial port. For example, serial port can be used to connect the computer system to a modem, which in turn connects to a wide area network such as the Internet, a mouse input device, or a scanner. The interconnection via system bus allows central processor 583 to communicate with each subsystem and to control the execution of instructions from system memory 582 or the fixed disk 589, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

In a specific embodiment, the present invention provides an overall system for live speed dating through a world wide network of computers. As shown above, the system can include one or more computer devices coupled to each other in a network. In a preferred embodiment, the system has one or more tangible computer readable medium, which can be volatile and/or non-volatile. Depending upon the embodiment, one or more computer codes can be provided on the tangible computer readable medium. A microprocessor device and associated operating software can execute the computer codes in the system. That is, one or more codes is configured to initiate a speed dating session from a client device between a first user and a plurality of second users by referencing a time from a timer. One or more codes is configured to output a first visual representation of the first user to one of the second users at a second client device. One or more codes configured to output a second visual representation of the second user to the first user at the first client device. One or more codes is configured to allow communication in a substantially real time between the first user and the second user through the network of computers. One or more codes is configured to accept an indication to determine if the one human user during a predetermined amount of time is an accept or a reject by the first human user. Depending upon the embodiment, there can be other codes to carry out the functionality described herein.

Although the above has been illustrated in terms of specific hardware features, it would be recognized that many variations, alternatives, and modifications can exist. For example, any of the hardware features can be further combined, or even separated. The features can also be implemented, in part, through software or a combination of hardware and software. The hardware and software can be further integrated or less integrated depending upon the application. Further details of certain methods according to the present invention can be found throughout the present specification and more particularly below.

### EXAMPLES

To prove the principle and operation of the present invention, we prepared an example. This example should not unduly limit the scope of the claims herein. One of ordinary skill in the art would recognize other variations, modifications, and alternatives. This example is provided over client devices such as computers and/or mobile devices (e.g., palmtops, laptops, cell phones, personal digital assistants) Further details of the present example can be found throughout the present specification and more particularly below.

Overview of Live Speed Dating (“LSD”) Process and System

Three forms of Speed Dating will be made available according to a specific embodiment:

1. Speed Dating Events—scheduled events with advertising and member sign up prior to event start. Each event will be 60 minutes in duration with 6 10-minute dating sessions (7 minutes in the live date and 3 minutes to vote and fill out any comments about session).

2. On Demand Speed Date—single session, entertainment value speed date, where we will randomly send invitations to online members who meet gender, sexual preference and age requirements until someone agrees or no matches found.

3. Live Request Speed Date—single session speed date where member searches database for possible match and then sends a specific speed date invitation to person they have found in search. (Note need to add Park capability back into site, may want to set up email notification or popup message when parked persons are online)

The supporting elements we decided to include in the LSD site were

Streamlined Social Networking Component similar to Friendster

Audio/Video Chat (initially as a supplement to dating segments but soon to become an independent service)

Text Chat

Directed Advertising (future element based on Text Chat, member demographics, and dating participation information)

Basic Revenue Model

We intend to provide free access to members for participation in Speed Dates and profile searching, but will charge for providing necessary information needed to actually communicate with matches from speed dates or member profile searches according to a specific embodiment.

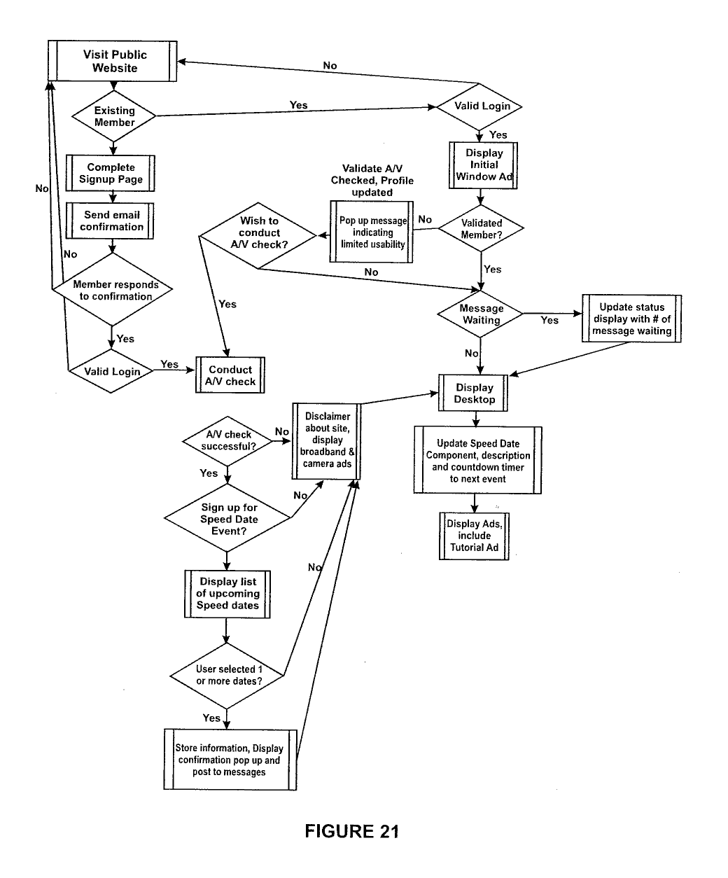

Ancillary revenue sources will include sale of advertising space on the site and 30 days after launch, sale of A/V Chat services based on a per minute or monthly fee. Depending upon the embodiment, elements of the speed dating process have been summarized below in reference to FIGS. 21, 22, 23, and 24.

Signup Work Flow (FIG. 21)

1. Potential member receives promotional ID from marketing effort or an invitation from existing member

2. Potential member logs into public HTML version of site and is provided form for basic signup and disclaimer agreements

3. On submittal of form, an email confirmation message is sent to potential member, at which time the userid and password provided in the signup are activated.

4. Member logs into LSD

a. Existing Member is dropped on to desktop

b. New Member—automatically dropped into test bandwidth, camera and audio/video screen

i. If unable to pass A/V and/or Bandwidth test, inform member, then drop member on desktop. First screen should be an advertisement for Broadband and Webcams. Screen must be closed before Desktop is available

ii. If member passes A/V test then immediately ask if they wish to sign up for a Speed Date Event

1. If answer is no then drop member to desktop. Need to identify which advertising screen should show up to be closed.

2. If answer is yes then:

a. Display list of upcoming Speed Dating Events.

b. Allow user to select event(s)

c. Upon submission of selection provide confirmation message, and then send event notice as message to member.

3. Drop member onto desktop

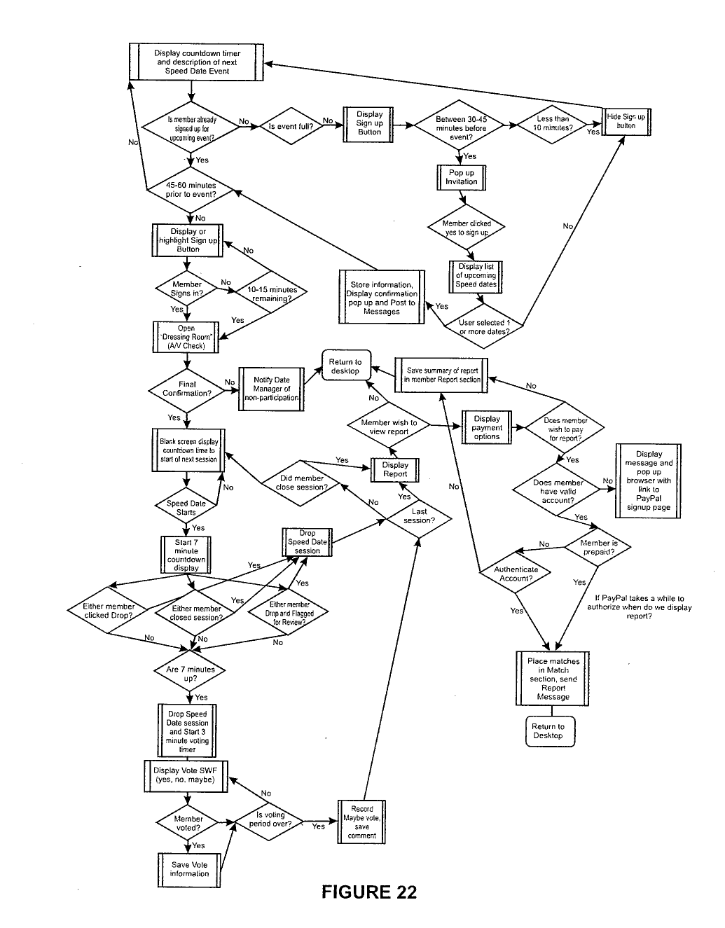

Basic Desktop Functions FIG. 22)

1. For non-subscribers always present an initial ad window which has to be closed prior to having access to the desktop

2. Three checks should be performed periodically, at least on startup:

a. A/V has been checked

b. Dating profile has been updated

c. Messages are waiting

3. Launch Pad is always visible

4. Left ad space is always visible

Speed Dating Event Workflow

1. Notification process

a. 48 hour notice is sent as a message

i. If user has email forward flag set, then server will also send message to assigned email

b. 24 hour notice is sent as a message

c. Speed Dating component has:

i. countdown timer that counts down to next event

ii. display of name and/or description of upcoming event

iii. Sign In button (for members who are anxious. Clicking takes them to dressing room.)

iv. Sign up button (available up until 5 minutes before event or event is full, for last minute participants)

d. 15 minute confirmation message is sent if member has not signed in

i. Member still wishes to participate and presses confirm, member is dropped into “Dressing Room”

ii. Member does not wish to participate, remove them from event list

2. Dressing Room

a. Single A/V display, allow user to test Video and Audio prior to Speed Date Event starting

b. Provide countdown timer to start of Speed Date Event

c. Once countdown timer is complete drop Dressing Room and place member(s) in 2 way Speed Dating chat windows.

3. Sessions

a. Each member participates in up to 6 individual 10 minute speed date sessions per Event. (7 minutes for the speed date and 3 minutes for the Vote and Comment section)

b. The Match Server will pass chat room and 2 memberIds to each Speed Date component. At the time a “match” is computed a new record is placed in the database. All other information related to the Speed Date session will be an update call from the Speed Date component.

c. If server is unable to find a match, message is provided member indicating “Unable to find suitable match”, and summary of previous sessions is provided.

d. Dating Session:

i. A 7-minute countdown timer should be visible for the date.

ii. Member is able to Drop date at anytime (this will terminate current date, but not remove them from remaining sessions)

iii. Member is able to Drop Date and Exit Session iv. Member is able to Drop Date and Flag for Review (other member is date either obscene, or other reason)

v. Member is able to update Comments during Date

iv. Either a flashing icon or some other method needs to let Member know that they are in the last 30 seconds of session

vii. At end of session then both A/V images are turned off.

e. Voting Session

i. A 3-minute countdown timer should be visible for the Vote

ii. Member is required to vote first (Yes, No, Maybe)

1. Yes—Member will potentially be added as a Match

2. No—Member is not added, and will not be used for any future matches

3. Maybe—Member is not added, and can be used for future matches

iii. After vote member has 3 minutes to add comments and save

iv. Provide reminder notice at 30 seconds remaining to save comment.

f. Report Session

i. Upon completion of all Dates, provide summary message to member regarding number of matches (to be counted as a match both participants must select yes). Only charge if at least 1 match occurred.

ii. Check if member is an unlimited subscriber

1. If an unlimited subscriber:

a. Transfer links for all matches to the “Matches” tab in the “Friendster” component

b. Send special Match Report Message, containing screen names, and links

2. If not a subscriber:

a. Ask member if they would like to review the report

b. If yes, then check if the have a valid account

i. If valid account then post pricing message

ii. If they agree to price then Create Debit transaction to database and follow steps 1a and 1b directly above

c. If not a valid account then take them to Pay Pal Account sign up page

i. If account set up successfully then Create Debit transaction to database and post Report information.

d. Otherwise save Report summary to Member list (as unpaid) and exit Speed Date Event component.

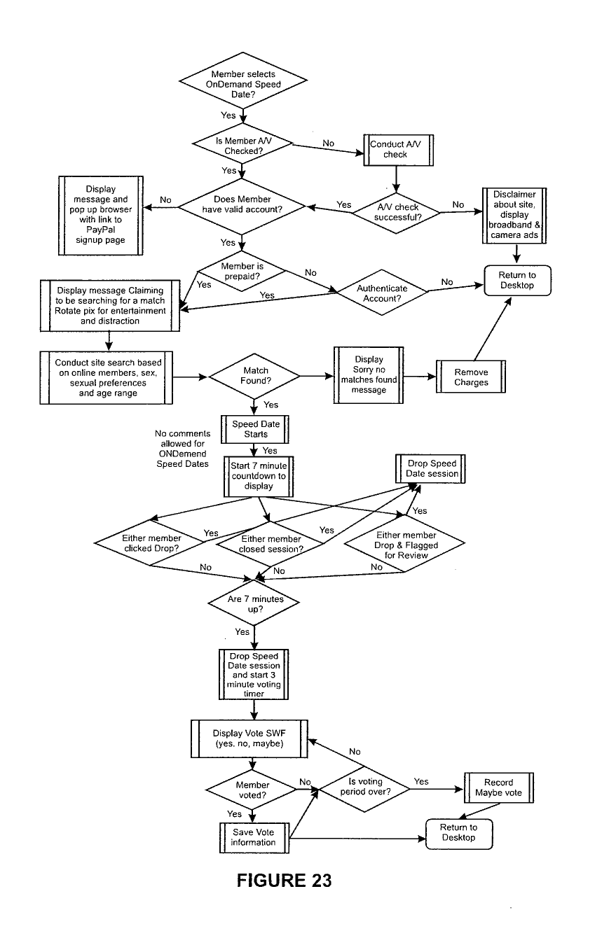

On Demand Speed Dating (FIG. 23)

1. Upon member login, each member is placed in a “bin” based on Gender, Sexual Preference and Age, for faster performance in On Demand Speed Dating

2. Member selects On Demand Speed Date “button”

3. Component tests:

a. General profile is complete, if not then member must at least fill in Gender and Sexual Preference, age will be determined by age of requesting member.

b. Member is A/V checked

c. Member has valid PayPal account

i. Send to PayPal signup page

d. Check if member has unlimited package

i. Member must agree to $0.99 price if not unlimited

4. Server looks in appropriate bin and sends out invitation messages in blocks of 25 to members in “bin” who are “ANV checked”.

a. If no takers then “Unable to find match at this time”

b. If someone responds yes

i. Start modified Speed Date Session

ii. 7 minute countdown time

iii. Vote at end of seven minutes

iv. Disable comments for On Demand Speed Date

c. If both participants say yes then add to Match section of each participant.

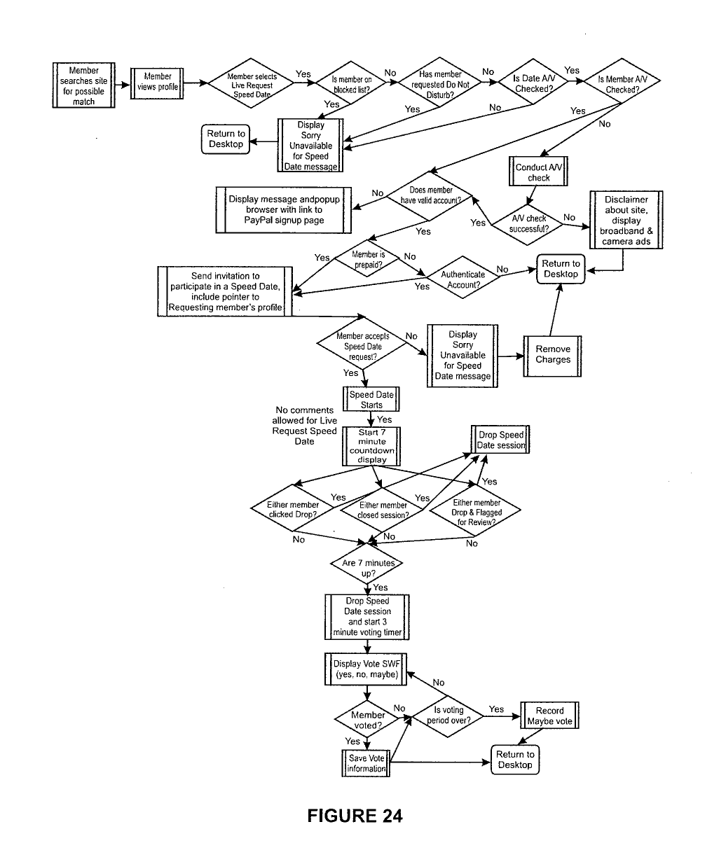

Live Request Speed Date (FIG. 24)

1. Member conducts search or is in “Cruise” mode and identifies potential matching member.

2. If requested member is not online allow image and ID to be “parked”

3. From “pop-up” menu available to non-friends, member selects “Request a Speed Date”

4. Validate

a. That requested member has been A/V checked

b. That requested member has not blocked this member

c. That requested member does not have “Do Not Disturb” flag set

5. If not validated, then provide message “This member is not currently able to conduct Speed Dates”

6. If validated, send message, including thumbnail of requesting member to participate in a speed date.

7. Remainder of process is the same as in the random On Demand speed dates

Although the above has been illustrated in terms of specific hardware features, it would be recognized that many variations, alternatives, and modifications can exist. For example, any of the hardware features can be further combined, or even separated. The features can also be implemented, in part, through software or a combination of hardware and software. The hardware and software can be further integrated or less integrated depending upon the application.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for live speed dating through a world wide network of computers, the method comprising:
inputting one or more parameters through a client device to a server device from a first human user, the one or more parameters including a sexual preference and an age range, the client device being coupled to the server device through a computer network coupled to a world wide network of computers;
processing the one or more parameters of the first human user;
maintaining a pool of more than two other human users to be matched with the first human user;
outputting at least a second visual image of one of the other human users to be matched with the one or more parameters of the first human user within a first predetermined amount of time to the first human user on the client device;
communicating from the first human user to at least one of the other human users for a second predetermined amount of time through the network of computers, the network of computers being configured for communicating in substantially real time between the first human user and the other human user; and
determining if the one human user during the second predetermined amount of time is an accept or a reject.

2. The method of claim 1 wherein the network of computers is the Internet and an enterprise network of computers.

3. The method of claim 1 wherein the communicating comprises outputting a first visual image of the first human user to the one or more other human users.

4. The method of claim 3 wherein the one or more other human users outputs a visual image of the other human users to the first human user.

5. The method of claim 4 wherein the outputting of the first human user and the outputting of the one or more other human users is provided simultaneously on a graphical user interface on a display of a client device.

6. The method of claim 1 wherein the communicating comprises transferring audio information from the first human user to the one or more other human users.

7. The method of claim 1 wherein the determining is provided by both the first human user and the one or more other human users.

8. The method of claim 1 wherein the determining consists of providing an accept indication by both of the first human user and the one or more other human users.

9. The method of claim 1 further comprising transferring information between the accepted.

10. The method of claim 1 wherein the determining comprises selecting a rating from 1 through N, where N is an integer greater than 1, for physical appearance.

11. The method of claim 1 wherein the determining comprises selecting a rating from 1 through N, where N is an integer greater than 1, for personality.

12. The method of claim 1 wherein the determining comprises selecting a rating from 1 through N, where N is an integer greater than 1, for intelligence.

13. The method of claim 1 wherein the determining comprises selecting a rating from 1 through N, where N is an integer greater than 1, for sexiness.

14. The method of claim 1 wherein the determining comprises selecting a separate rating from 1 through N, where N is an integer greater than 1, for physical appearance, personality, intelligence, and sexiness.

15. The method of claim 1 further comprising inputting text information from the first human user to be sent to the one or more other human users, the text information being a testimonial from the first human user to one of the one or more other human users.

16. A method for live speed dating through a world wide network of computers, the method comprising:
inputting one or more parameters through a client device to a server device from a first human user, the one or more parameters including a sexual preference and an age range, the client device being coupled to the server device through a computer network coupled to a world wide network of computers;
processing the one or more parameters of the first human user;
deriving a pool of more than two other human users to be matched with the first human user from the one or more parameters from the first human user;
initiating a dating session between the first human user and one of the other human users;
outputting at least a second visual image of the one other human user within a first predetermined amount of time to the first human user on the client device;
communicating in substantially real time between the first human user to the one of the other human users for a second predetermined amount of time through the network of computers;
selecting an appearance rating from 1 through N, where N is the integer greater than 1, for appearance of the one of the other human users by the first human user;
selecting a personality rating from 1 through M, where M is an integer greater than 1, for personality of the one of the other human users by the first human user;
selecting an intelligence rating from 1 through O, where O is an integer greater than 1, for intelligence of the one of the other human users by the first human user;
selecting a sexiness rating from 1 through P, where P is an integer greater than 1, for sexiness of the one of the other human users by the first human user; and
determining if the one human user during the second predetermined amount of time is an accept or a reject by the first human user.

17. The method of claim 16 wherein the network of computers is the Internet and an enterprise network of computers.

18. The method of claim 16 wherein the communicating comprises outputting a first visual image of the first human user to the one or more other human users.

19. The method of claim 18 wherein the one or more other human users outputs a visual image of the other human users to the first human user.

20. The method of claim 19 wherein the outputting of the first human user and the outputting of the one or more other human users is provided simultaneously on a graphical user interface on a display of a client device.

21. The method of claim 16 wherein the communicating comprises transferring audio information from the first human user to the one or more other human users.

22. The method of claim 16 wherein the determining is provided by both the first human user and the one or more other human users.

23. The method of claim 16 wherein the determining consists of providing an accept indication by both of the first human user and the one or more other human users.

24. The method of claim 16 further comprising transferring information between the accepted.

25. The method of claim 16 further comprising inputting text information from the first human user to be sent to the one or more other human users, the text information being a testimonial from the first human user to one of the one or more other human users.

26. A method for live speed dating through a world wide network of computers, the method comprising:
initiating a speed dating session from a client device between a first user and a plurality of second users by referencing a time from a timer, the client device being coupled to a server device through a computer network coupled to a world wide network of computers;
outputting a first visual representation of the first user to one of the second users at a second client device, the second client device being coupled to the server device through the computer network;
outputting a second visual representation of the second user to the first user at the first client device;
communicating in substantially real time between the first user and the second user through the network of computers; and
determining if the one human user during a predetermined amount of time is an accept or a reject by the first human user.

27. The method of claim 26 wherein the predetermined amount of time is about one minute or less and wherein the outputting of the first visual representation, the outputting of the second visual representation, communicating are provided during the predetermined amount of time.

28. A system for live speed dating through a world wide network of computers, the system comprising one or more tangible computer readable medium including:
one or more codes configured to initiate a speed dating session from a client device between a first user and a plurality of second users by referencing a time from a timer, the client device being coupled to a server device through a computer network coupled to a world wide network of computers;
one or more codes configured to output a first visual representation of the first user to one of the second users at a second client device, the second client device being coupled to the server device through the computer network;
one or more codes configured to output a second visual representation of the second user to the first user at the first client device;
one or more codes configured to allow communication in a substantially real time between the first user and the second user through the network of computers; and
one or more codes configured to accept an indication to determine if the one human user during a predetermined amount of time is an accept or a reject by the first human user.
